(19) United States
(12) Patent Application Publication
(10) Pub. No.: US 2012/0169022 A1
(43) Pub. Date: Jul. 5, 2012

(54) ANTI-ROLL BAR FOR A MOTOR VEHICLE AND METHOD FOR ITS PRODUCTION

(75) Inventors: Christian Schulz, Liebenburg (DE); Tom-Hendrik Braun, Wolfenbuettel (DE)

(73) Assignee: IFA-TECHNOLOGIES GMBH, Haldensleben (DE)

(21) Appl. No.: 13/394,644

(22) PCT Filed: Sep. 10, 2010
(86) PCT No.: PCT/DE10/01066

§ 371 Date: Mar. 7, 2012

(30) Foreign Application Priority Data
Sep. 10, 2009 (DE) 10 2009 041 038.4

(51) Int. Cl. B60G 21/05; B29C 45/00

(52) U.S. Cl. 280/124.106; 264/328.1

(57) ABSTRACT

The invention relates to an anti-roll bar for a motor vehicle, the anti-roll bar being one-piece or multi-piece and being composed of a torsion rod (12) and bent rotating legs (14) on both sides, the free ends (16) of which can each be connected to a wheel suspension of the motor vehicle by means of swivel joints, wherein the anti-roll bar (11) is formed from a resin-bonded main body. According to the invention, the main body consists of a cord (4), which achieves stiffness by curing the resin. The cord (4) is introduced into a closed tool as a preform and resin is injected into the tool. This has the advantage that, for the installation of the anti-roll bar according to the invention, the assemblies and elements that have already been used on motor vehicles for this purpose and have been tested with regard to driving safety can be left unchanged in the essential characteristics thereof, which is a result of the design and shape of the presented anti-roll bar and of the selection of the material of the presented anti-roll bar.

The invention proceeds from an anti-roll bar for a motor vehicle according to the preamble of claim 1, and a method for its production according to the preamble of claim 7.

Motor vehicles tend to sway in road traffic, which is generally not intended, the cause for this lies in stresses that act on the motor vehicle from the outside. Such stresses occur not only when driving straight ahead but also, for example, in curves, in the event of unevenness of the road surface, in uneven terrain or in the case of a lateral wind load, as well as during braking and accelerations.

To avoid such swaying movements, it is generally known that individual axles or every axle of a motor vehicle has an anti-roll bar that functions according to the torsion rod principle assigned to it. This anti-roll bar can be configured in one piece or also in multiple pieces, and has the task of counteracting the forces that provoke sway of the vehicle during operation, and thus of restricting the swaying movement to a minimum.

Anti-roll bars are known that are formed from a round steel or also from a hollow shaft. However, these have the disadvantage that their weight is relatively great, for one thing, particularly in the case of solid material composite rods.

Furthermore, anti-roll bars are known that consist of a plastic reinforced with carbon fibers, whereby bearing eyes provided on the anti-roll bar as well as end-side accommodations for force introduction elements are also incorporated into the fiber composite of the basic shape of the anti-roll bar (DE 36 12 777). However, anti-roll bars produced in this manner have the disadvantage that because of the link locations and connection locations that are included as part of the design, they can always be used only for very specific vehicle types, namely those designed for these link locations and connection locations. Furthermore, their production is connected with a relatively great amount of effort. The fibers are saturated with resin and wound onto a core, wet, and this core is then inflated in a mold. Afterward, additional layers are applied there, wet. It is furthermore disadvantageous that in the case of this method of procedure, a so-called laminate-rough surface is formed, which technically cannot be used as a bearing surface, for example.

Furthermore, a stabilizer bar is known, which comprises a fiber-reinforced composite bar that consists of a plurality of fibers that are embedded in a resin/plastic binder. Metallic arms are connected with its two ends, with shape fit and force fit. The composite bar can be produced by means of rolling technology, using the blow-molding process, or using the filament winding process (DE 602 22 494 T2). These production methods are relatively complicated and are directed solely to the production of the composite bar.

The invention is therefore based on the task of creating an anti-roll bar for motor vehicles, whose weight is reduced and which can be universally used, and which can be produced in simple manner.

According to the invention, this task is accomplished with the characteristics of claims 1 and 7.

Particular embodiments and advantageous solutions of the invention are indicated in the dependent claims.

### THE INVENTION AND ITS ADVANTAGES

The invention has the advantage that for installation of the anti-roll bar according to the invention, the modules and components that are already in use on motor vehicles for this purpose and have proven themselves in terms of vehicle safety technology can be left unchanged in terms of their essential characteristics, as provided, for one thing, by the configuration and shape, and for another, by the selection of the material of the anti-roll bar being presented.

This is achieved by means of an anti-roll bar whose base body consists of a rope as a preform, which is laid into a closed tool and then infiltrated with a resin. After the base body has cured, the anti-roll bar is completed with the parts or modules required for the introduction of force, which are provided for this purpose as a function of the vehicle type for which it is supposed to be used, in each instance.

Another advantage of the invention consists in that ropes produced industrially in ropeyards as goods by the meter can be used as the preforms. As a result, the production of the anti-roll bars becomes very cost-advantageous even for different vehicle types.

According to an advantageous embodiment of the invention, the rope consists of a core around which fibers are wound or braided. All types of inorganic and organic fibers can be used as fibers.

According to an embodiment of the invention that is advantageous in this regard, a hose, an elastic pipe, a fiber bundle or merely a simple rope without particular requirements, for example a non-braided rope, is used as the core.

According to an additional advantageous embodiment of the invention, the fibers are disposed around the core of the rope in an angle of 45°. In this connection, the most unidirectional arrangement possible is more practical than simply winding the fibers around in a 45° layer, followed by a 45° layer in the opposite direction.

According to another advantageous embodiment of the invention, the core of the rope is surrounded by a woven structure. A lesser rigidity of the rope that might occur in this connection is eliminated by the subsequent treatment of the rope.

Aside from the material selection in the formation of the anti-roll bar, the advantage that the anti-roll bar can be adapted to the circumstances prevailing in the vehicle, in terms of its spring stiffness, is connected with the method for production of the anti-roll bar being presented. As the result of this possibility in the production of the anti-roll bar, broad use of the anti-roll bar is made possible, because the prevailing design conditions and the arrangement of functional parts in a motor vehicle can be maintained, in terms of their shape and placement, and the anti-roll bar is adapted to these prevailing conditions, thereby achieving advantages both in the assembly of such anti-roll bars and in their function.

According to another advantageous embodiment of the invention, the anti-roll bar has different cross-sectional shapes over its length, whereby, however, the cross-sectional area remains constant, independent of its shape. The cross-section of the anti-roll bar is advantageously circular in those regions in which torsion stresses are predominantly present. In the region in which the torsion stresses have bending stresses superimposed on them, which are primarily the regions of the transition from the torsion rod to the rotating shanks, other cross-sectional shapes, for example elliptical cross-sections, are possible.

The method for production of the anti-roll bar consists in that the corresponding rope is laid into a tool that is closed off by way of a counter-mold, so that it is sealed for resin. Afterward, a resin is pressed into the tool, which resin displaces the remaining air from the preform and saturates the rope that is laid in, while doing so.

Alternatively, a rope presaturated with resin, a so-called prepreg, can also be laid into a tool and then can cure there, under pressure and temperature.

After curing and unmolding, appropriate machining processes can be undertaken on the anti-roll bar produced in this manner, in order to affix connection elements to the anti-roll bar, by means of which the bar can be affixed in the motor vehicle.

According to the invention, the tool is configured with a mold that corresponds, for one thing, to the cross-section of the anti-roll bar and to its longitudinal configuration, for another thing. Here, the advantage of the method particularly comes to bear, that the anti-roll bar according to the invention can be adapted to the prevailing operating and placement conditions as well as to the configuration of the motor vehicle parts in the motor vehicle, in each instance, without any changes having ₜo be made in their configuration and placement. By means of a corresponding configuration of the mold cavity of the tool, different cross-sectional shapes can also be implemented over the length of the stabilizer.

Further advantages and advantageous embodiments of the invention can be derived from the following description, the drawing, and the claims.

### DRAWING

An exemplary embodiment of the invention is shown in the drawings and described in greater detail below. In the drawings, the figures show:

FIG. 1 a tool for the production of an anti-roll bar,

FIG. 2 a sectional view through the tool, and

FIG. 3 an anti-roll bar having different cross-sectional regions.

### DESCRIPTION OF THE EXEMPLARY EMBODIMENT

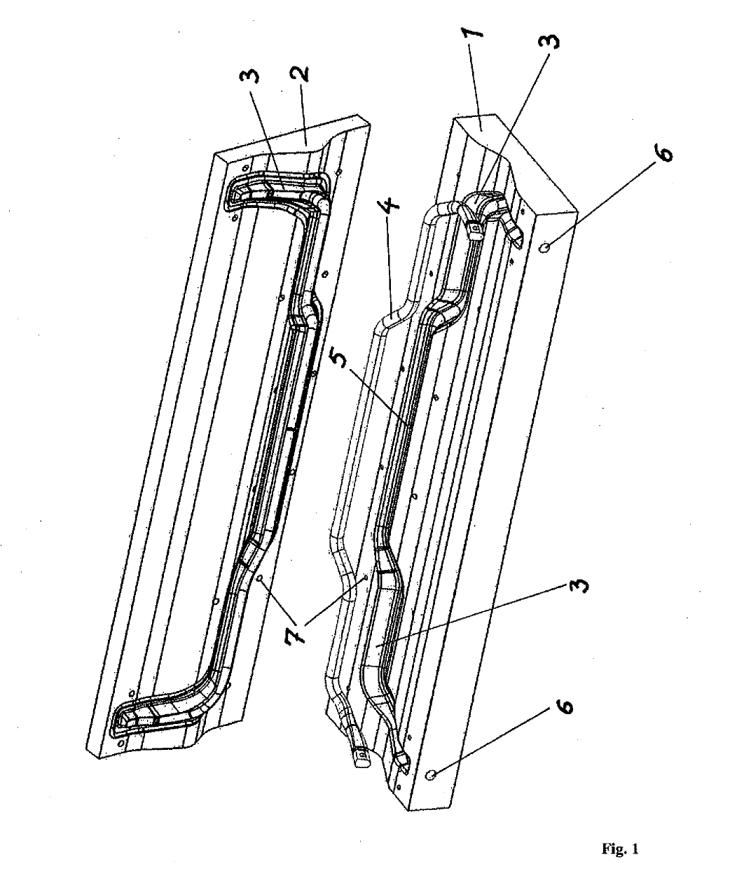

FIG. 1 shows the configuration of a tool for the production of a transverse anti-roll bar, which consists of a lower part 1 and an upper part 2, into which a mold cavity 3 is worked, in each instance, which cavity corresponds to the shape of the anti-roll bar to be produced. Above the lower part 1, a rope 4 to be laid into the mold cavity 3, already in the shape corresponding to the anti-roll bar, is shown.

In the lower part 1 of the tool, a resin inlet 5 is provided, also the tool is equipped with resin overflows 6. In the mold parting plane of lower part and upper part 1, 2, bores 7 for fixation of the two parts are provided.

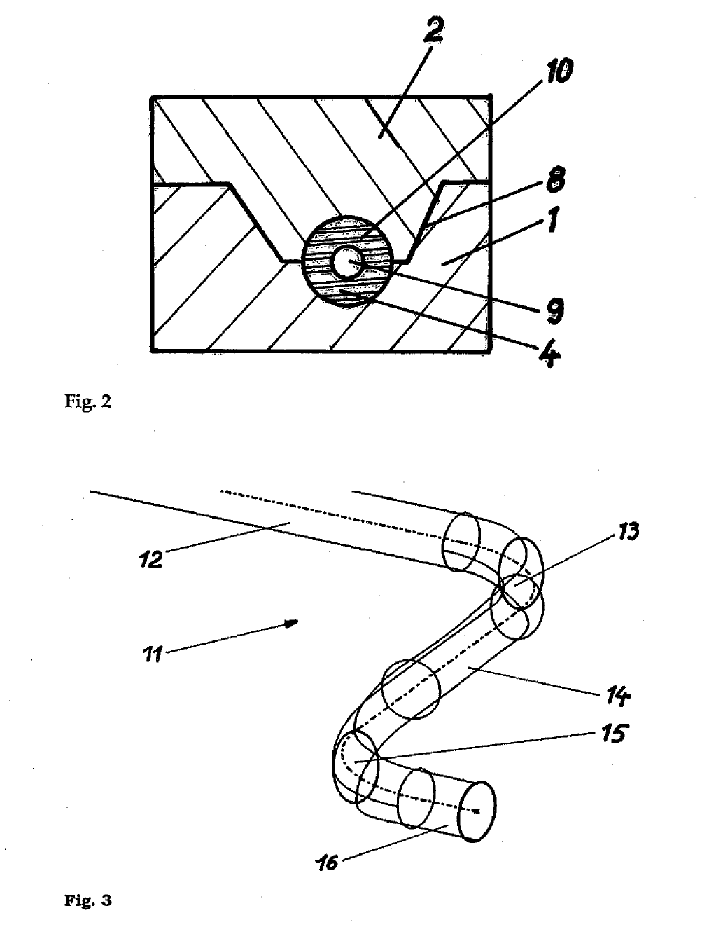

From the sectional representation of the closed tool in FIG. 2, it can be seen that the mold parting plane is laid into the diameter plane of the rope 4 and that lower part and upper part 1, 2 have positioning sants 8. The positioning slants 8 serve for precise assignment of upper part and lower part 1, 2, and thereby ensure precise closing of the entire tool, without displacements occurring in the mold parting plane.

FIG. 2 illustrates the configuration and assignment of lower part and upper part 1, 2 relative to one another. When the tool is closed, the mold cavity 3 is completely filled by the rope 4, which has a core 9 at its center in the present example, and has fibers 10 wound around it. After the tool is closed, a liquid synthetic resin is pressed into the tool by way of a resin inlet 5, which resin fills all the interstices between the individual fibers 10 and those between the fibers 10 and the core 9.

Once the filling process has been completed, the curing process can begin.

FIG. 3 shows one end of an anti-roll bar 11 produced according to the invention, which consists of a torsion rod 12 and two rotating shanks 14 angled away relative to the rod by 90°, in a plane having a radius 13. The latter shanks are angled away once again in the same plane, relative to an end piece 16, at a radius 15, by 90° in the opposite direction. In the regions that run straight, in each instance, the cross-sections are circular, in the regions of the radii 13 and 15 they are configured to be elliptical. The rope 4 participates in the shape change by way of being forced into the mold cavity 3.

All of the characteristics represented in the specification, the following claims, and the drawing can be essential to the invention not only individually but also in any desired combination with one another.

### REFERENCE NUMBER LIST

1 lower part
2 upper part
3 mold cavity
4 rope
5 resin inlet
6 resin overflow
7 bore
8 positioning slant
9 core
10 fibers
11 anti-roll bar
12 torsion rod
13 radius
14 rotating shank
15 radius
16 end piece

1-8. (canceled)

9. Anti-roll bar for a motor vehicle, which bar is structured in one piece and consists of a torsion rod (12) and rotating shanks (14) that are angled away on both sides, the free ends (16) of which shanks can be connected with the wheel suspension of the motor vehicle by way of rotating joints, in each instance, wherein the anti-roll bar (11) is formed from a base body bound by a resin, wherein the base body consists of a rope (4) that achieves its rigidity by means of curing of the resin, wherein the rope (4) has a core (9) around which fibers (10) are wound or braided, which core consists of a hose or a pipe.

10. Anti-roll bar according to claim 9, wherein the core (9) of the rope (4) has a woven structure woven around it.

11. Anti-roll bar according to claim 9, wherein the fibers (10) are disposed around the core (9) at an angle of preferably 45°.

12. Anti-roll bar according to claim 9, wherein the anti-roll bar (11) has different cross-sectional shapes over its length, wherein the cross-sectional area remains constant.

13. Method for the production of an anti-roll bar for motor vehicles, which bar is structured in one piece and consists of a torsion rod (12) and rotating shanks (14) that are angled away on both sides, the free ends (16) of which shanks can be connected with the wheel suspension of the motor vehicle by way of rotating joints, in each instance, wherein the anti-roll bar (11) is formed from a base body bound by a resin, wherein a rope (4) is used as the base body, which rope is introduced into a closed tool as a preform, wherein resin is injected into the tool, and wherein the rope (4) cures in the tool.

14. Method for the production of an anti-roll bar for motor vehicles, which bar is structured in one piece and consists of a torsion rod (12) and rotating shanks (14) that are angled away on both sides, the free ends (16) of which shanks can be connected with the wheel suspension of the motor vehicle by way of rotating joints, in each instance, wherein the anti-roll bar (11) is formed from a base body bound by a resin, wherein a rope (4) is used as the base body, which rope is saturated with resin as a preform, and subsequently cures in the closed tool.
